(19) United States
(12) Patent Application Publication
(10) Pub. No.: US 2026/0078010 A1
(43) Pub. Date: Mar. 19, 2026

(54) METHOD OF PRODUCING ZEOLITE FROM AN ACID-REFRACTORY MINERAL COMPOSITION

(71) Applicant: Commonwealth Scientific and Industrial Research Organisation, Acton, Australian Capital Territory (AU)

(72) Inventors: Robbie Gordon MCDONALD, Waterford, Western Australia (AU); Nicole Markia CHAPMAN, Waterford, Western Australia (AU)

(21) Appl. No.: 19/109,420

(22) PCT Filed: Sep. 7, 2023
(86) PCT No.: PCT/AU2023/050864

§ 371 Date: Mar. 6, 2025

(30) Foreign Application Priority Data
Sep. 8, 2022 (AU) 2022902587

(51) Int. Cl. C01B 39/46

(52) U.S. Cl. CPC C01B 39/46; C01P 2002/72

(57) ABSTRACT

The invention provides a method of producing zeolite from an acid-refractory mineral composition, the method comprising: (a) treating an acid-refractory mineral composition comprising aluminosilicate with an alkaline solution to dissolve silicon from the aluminosilicate into the alkaline solution, thereby producing an alkaline silicate solution and an aluminium-bearing mineral residue; (b) separating the alkaline silicate solution from the aluminium-bearing mineral residue; (c) contacting the aluminium-bearing mineral residue with an acid solution to dissolve aluminium from the aluminium-bearing mineral residue into the acid solution, thereby producing an aluminium salt solution and an aluminium-lean solid residue; (d) separating the aluminium salt solution from the aluminium-lean solid residue; (e) combining at least a portion of the alkaline silicate solution and at least a portion of the aluminium salt solution to form a zeolite precursor solution; and (f) precipitating a zeolite from the zeolite precursor solution.

### PRIORITY CROSS-REFERENCE

The present application claims priority from Australian provisional patent application No. 2022902587 filed on 8 Sep. 2022, the contents of which should be considered to be incorporated into this specification by this reference.

### TECHNICAL FIELD

The invention generally relates to a method of producing zeolite from an acid-refractory mineral composition. The method comprises treating an acid-refractory mineral composition comprising aluminosilicate with an alkaline solution to produce an alkaline silicate solution and an aluminium-bearing mineral residue, contacting the aluminium-bearing mineral residue with an acid solution to produce an aluminium salt solution and an aluminium-lean solid residue, combining the alkaline silicate solution and the aluminium salt solution and precipitating zeolite from the combined solution. The invention is particularly applicable for the upgrading of lithium leach residue such as β-spodumene leach residue, and it will be convenient to disclose the invention in relation to that exemplary embodiment.

### BACKGROUND OF INVENTION

Expanding worldwide demand for lithium, particularly for battery applications, must increasingly being be met by lithium extraction from hard rock ores or concentrates containing α-spodumene, i.e. LiAl(SiO₃)₂, or other lithium-bearing aluminosilicate minerals. In a common process, naturally occurring α-spodumene is converted to the more reactive β-spodumene form by calcination and the lithium is extracted from the ore or concentrate by roasting with sulfuric acid and aqueous leaching of the roasted product. The spodumene leach residue, representing approximately 95 wt. % of the initial feed, comprises HAl(SiO₃)₂ as a major component. The disposal of this Class III waste product as tailings imposes significant operating costs and environmental hazard.

It would be desirable to upgrade β-spodumene leach residue or other lithium leach residues to extract values therefrom and to offset the cost of disposal. However, these materials are generally refractory to hot acids and cannot be processed by acidic hydrometallurgical processes.

It has previously been proposed to upgrade lithium leach residues by conversion to zeolites via an alkaline treatment. In WO 2019/068135, for example, β-spodumene leach residue is mixed with an aqueous caustic soda solution and heated to a high temperature (about 600° C.) to form a fused solid product which is then cooled and transformed into Zeolite A in the presence of added water.

A significant difficulty with this approach is that the selective production of a range of desired zeolite products is constrained in a process which involves a dissolution-reprecipitation mechanism to convert the acid-refractory aluminosilicate into zeolites. Moreover, there is a risk that the resultant zeolites will be contaminated with refractory impurities derived from the lithium leach residue, including components such as quartz. Furthermore, the high temperatures required to produce certain desirable zeolite products via fusion with caustic soda imposes significant energy costs.

While the above discussion has focused on the processing of lithium leach residues such as β-spodumene residue, it will be appreciated that similar considerations apply to the upgrading of a range of acid-refractory mineral compositions comprising aluminosilicates.

There is therefore an ongoing need for a method of producing zeolite from acid-refractory mineral compositions, such as lithium leach residues, which at least partially addresses one or more of the above-mentioned short-comings, or provides a useful alternative.

A reference herein to a patent document or other matter which is given as prior art is not to be taken as an admission that the document or matter was known or that the information it contains was part of the common general knowledge as at the priority date of any of the claims.

### SUMMARY OF INVENTION

In accordance with a first aspect, the invention provides a method of producing zeolite from an acid-refractory mineral composition, the method comprising: (a) treating an acid-refractory mineral composition comprising aluminosilicate with an alkaline solution to dissolve silicon from the aluminosilicate into the alkaline solution, thereby producing an alkaline silicate solution and an aluminium-bearing mineral residue; (b) separating the alkaline silicate solution from the aluminium-bearing mineral residue; (c) contacting at least a portion of the aluminium-bearing mineral residue with an acid solution to dissolve aluminium from the aluminium-bearing mineral residue into the acid solution, thereby producing an aluminium salt solution and an aluminium-lean solid residue; (d) separating the aluminium salt solution from the aluminium-lean solid residue; (e) combining at least a portion of the alkaline silicate solution and at least a portion of the aluminium salt solution to form a zeolite precursor solution; and (f) precipitating a zeolite from the zeolite precursor solution.

The zeolite products produced according to this method crystallise and precipitate from a zeolite precursor solution, and are not formed by converting the acid-refractory mineral composition into zeolite(s) via transformation of one solid form into another, e.g. via a dissolution-reprecipitation mechanism. Advantageously, this approach to zeolite synthesis provides an improved opportunity to prepare specific zeolite structures of interest with good selectivity and purity, because the composition of the zeolite precursor solution and the precipitation conditions can be accurately controlled. Furthermore, zeolite products of high purity may be produced because insoluble impurities present in the feed material can be excluded.

The alkaline treatment step in the present method may advantageously be performed at low temperature because the process conditions of this step are not determinative of the final zeolite product selectivity. Thus, the high energy and capital costs associated with high temperature alkaline treatment of the acid-refractory mineral composition can be avoided.

In addition, the methods disclosed herein can be flexibly adapted to recover a high proportion of metal values in the acid-refractory mineral composition feed material, even when silicon is in excess relative to the stoichiometry of the zeolite products. Thus, for example, a high purity silica product can readily be recovered from the aluminium-lean solid residue, or an aluminium source such as gibbsite can be added to improve the conversion of dissolved silicon to desirable zeolite products.

In some embodiments, the acid-refractory mineral composition comprises an acid-treated mineral residue.

In some embodiments, the acid-refractory mineral composition comprises a leach residue from a lithium leach process. The leach residue may comprise β-spodumene leach residue.

In some embodiments, the acid-refractory mineral composition comprises HAl(SiO₃)₂, for example in an amount of at least 50 wt. % of the acid-refractory mineral composition.

In some embodiments, the aluminium-bearing mineral residue comprises one or more acid-extractable phases selected from sodalites, cancrinites and zeolites, for example in a combined amount of at least 50 wt. % of the aluminium-bearing mineral residue.

In some embodiments, the acid-refractory mineral composition is treated with the alkaline solution at a temperature of below 300° C., or below 200° C., such as below 150° C.

In some embodiments, the aluminium salt solution produced by contacting the aluminium-bearing mineral residue with the acid solution has a pH value of below 3.5.

In some embodiments, the aluminium-lean solid residue comprises silica, for example in an amount of at least 50 wt. %. The silica may be coagulated by controlling or adjusting the pH of the aluminium salt solution to between 3 and 5, such as between 3 and 4, before separating the aluminium salt solution from the aluminium-lean solid residue. The pH of the aluminium salt solution may be adjusted by alkalising the aluminium salt solution initially produced by contacting the aluminium-bearing mineral residue with the acid solution. Optionally, the aluminium salt solution initially produced is alkalised with a portion of the alkaline silicate solution.

In some embodiments, the method further comprises at least one of (i) extracting residual silicon from the aluminium-lean solid residue for the production of high purity silica, and (ii) dissolving residual silicon from the aluminium-lean solid residue in the alkaline solution or the alkaline silicate solution.

In some embodiments, the method further comprises adding an aluminium source, optionally gibbsite, to supplement the aluminium present in the zeolite precursor solution as derived from the acid-refractory mineral composition.

In some embodiments, the alkaline solution comprises an alkali metal hydroxide selected from lithium hydroxide, sodium hydroxide, potassium hydroxide and mixtures thereof. In some embodiments the alkaline solution comprises sodium hydroxide.

In some embodiments, the acid solution comprises an acid selected from sulfuric acid, hydrochloric acid, nitric acid and mixtures thereof.

In some embodiments, the method further comprises: separating the precipitated zeolite from a depleted solution comprising alkali metal sulfate or alkali metal chloride salt; and regenerating alkali metal hydroxide base for the alkaline solution by bipolar membrane electrodialysis or electrolysis of the depleted solution.

In some embodiments, precipitating a zeolite from the zeolite precursor solution comprises selectively precipitating a target zeolite by controlling precipitation process parameters including the Si:Al ratio in the zeolite precursor solution. The Si:Al ratio may be controlled by at least one selected from (i) controlling the relative amounts of the alkaline silicate solution and the aluminium salt solution combined in the zeolite precursor solution and (ii) adding an aluminium source to the zeolite precursor solution.

In some embodiments, precipitating the zeolite from the zeolite precursor solution comprises maintaining the zeolite precursor solution at a temperature in the range of 60° C. to 110° C.

In some embodiments, the zeolite is selected from the group consisting of Zeolite A, Zeolite X, Zeolite P and combinations thereof.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 is block flow diagram which schematically depicts a method of producing zeolite from an acid-refractory mineral composition according to some embodiments of the invention.

FIG. 2 is a plot of dissolved aluminium and silicon present in the alkaline solution as a function of time when treating β-spodumene leach residue with a 4 M NaOH solution in Example 2.

FIG. 3 is a plot of dissolved aluminium and silicon present in the alkaline solution as a function of time when treating β-spodumene leach residue with a 10 M NaOH solution in Example 2.

FIG. 4 shows an X-Ray Diffraction (XRD) pattern of Zeolite X precipitated at 70° C. from a zeolite precursor solution (Si:Al=2.3) produced by combining synthetic alkaline silicate solution and synthetic aluminium sulfate solution in Example 5.

FIG. 5 shows an XRD pattern of Zeolite A precipitated at 70° C. from a zeolite precursor solution (Si:Al=1.6) produced by combining synthetic alkaline silicate solution and synthetic aluminium sulfate solution in Example 5.

FIG. 6 shows an XRD pattern of Zeolite P produced by subjecting Zeolite X to alkaline treatment at 95° C. in Example 5.

FIG. 7 shows an XRD pattern of Zeolite A precipitated at 70° C. from a zeolite precursor solution (Si:Al=2.2) produced by combining alkaline silicate and aluminium sulfate solutions, derived from β-spodumene leach residue according to embodiments of the invention in Example 6.

FIG. 8 shows an XRD pattern of Zeolite X precipitated at 70° C. from a zeolite precursor solution (Si:Al=1.0) produced by combining alkaline silicate and aluminium sulfate solutions, derived from β-spodumene leach residue according to embodiments of the invention in Example 6.

### DETAILED DESCRIPTION

The present invention relates to a method of producing zeolite from an acid-refractory mineral composition which comprises aluminosilicate. The method comprises at least the following steps (a)-(f).

Step (a). An acid-refractory mineral composition comprising aluminosilicate is treated with an alkaline solution to dissolve silicon from the aluminosilicate into the alkaline solution. An alkaline silicate solution and an aluminium-bearing mineral residue is thus produced. The alkaline treatment transforms the aluminosilicate phases initially present in the mineral composition so that the resulting aluminium-bearing mineral residue is no longer refractory to acid extraction.

Step (b). The alkaline silicate solution produced in step (a) is separated from the aluminium-bearing mineral residue.

Step (c). At least a portion of the aluminium-bearing mineral residue separated in step (b) is then contacted with an acid solution to dissolve aluminium from the aluminium-bearing mineral residue into the acid solution. An aluminium salt solution and an aluminium-lean solid residue is thus produced.

Step (d). The aluminium salt solution produced in step (c) is separated from the aluminium-lean solid residue.

Step (e). At least a portion of the alkaline silicate solution separated in step (b) and at least a portion of the aluminium salt solution separated in step (d) are then combined to form a zeolite precursor solution.

Step (f). A zeolite is precipitated from the zeolite precursor solution.

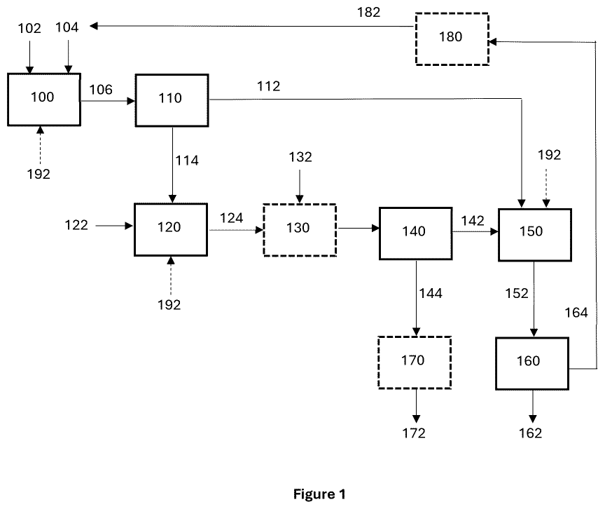

A method according to some embodiments is schematically depicted in block flow format in FIG. 1. In alkaline treatment unit 100 for performing step (a), acid-refractory mineral composition 102, which comprises aluminosilicate, is treated with alkaline solution 104 under conditions where silicon from the aluminosilicate dissolves into the alkaline solution. Acid-refractory mineral composition 102 may optionally be a β-spodumene leach residue containing predominantly HAl(SiO₃)₂ as the aluminosilicate. Alkaline solution 104 may optionally be an aqueous caustic soda (NaOH) solution.

After the alkaline treatment, the resulting slurry 106 is sent to separation unit 110 for performing step (b), for example a filtration unit, where alkaline silicate solution 112 and aluminium-bearing mineral residue 114 are separated. Typically, aluminium-bearing mineral residue 114 comprises one or more new aluminosilicate phases, such as sodalites and/or various zeolitic phases.

Aluminium-bearing mineral residue 114 is then sent to acid extraction unit 120 for performing step (c), where it is contacted with acid solution 122 under conditions where aluminium from the aluminium-bearing mineral residue dissolves into the acid solution. Acid solution 122 may optionally be an aqueous sulfuric acid, hydrochloric acid or nitric acid solution.

After the acid extraction, the resulting slurry 124 is sent to separation unit 140 for performing step (d), for example a filtration unit, where aluminium salt solution 142 and aluminium-lean solid residue 144 are separated. In some embodiments, slurry 124 as initially produced in acid extraction unit 120 will comprise amorphous silica gel. Optionally, slurry 124 is thus alkalised with base 132, either in a separate prefiltration unit 130 as shown or as a final stage in acid extraction unit 120, to coagulate the amorphous silica present in slurry 124 prior to the separation.

In zeolite precursor preparation unit 150 for performing step (e), at least a portion of alkaline silicate solution 112 separated in separation unit 110 and at least a portion of aluminium salt solution 142 separated in step (d) are combined to form a zeolite precursor solution 152. Typically, the relative amounts of alkaline silicate solution 112 and aluminium salt solution 142 are selected to provide a desired Si:Al ratio in zeolite precursor solution 152, for example a Si:Al ratio of between 2.5:1 and 1.0:1.

Zeolite 162 is then precipitated from zeolite precursor solution 152 in step (f) under conditions suitable to promote zeolite formation, either in a separate precipitation unit 160 as shown or in a combined zeolite synthesis unit for performing steps (e) and (f). A desired zeolite may be formed by controlling parameters such as the Si:Al ratio and temperature of the zeolite precursor solution, by adding seed material or templating agents, or by subjecting the initially precipitated zeolite to conditions suitable to induce solid-state phase transformation. Zeolites such as Zeolite A, Zeolite X and Zeolite P can thus be prepared with good purities.

Precipitated zeolite 162 may be separated from depleted solution 164, which may comprise sodium sulfate, sodium chloride or sodium nitrate if sulfuric acid, hydrochloric acid or nitric acid solutions 122 were used, in a further separation unit (not shown), and depleted solution 164 may optionally be processed by bipolar membrane electrodialysis or electrolysis in regeneration unit 180 to regenerate at least base 182 for recycling to alkaline solution 104.

Silicon introduced to the process via acid-refractory mineral composition 102 is typically in excess to aluminium based on the target zeolite product stoichiometry. In some embodiments, the process is thus operated so that excess silicon reports to aluminium-lean solid residue 144. This material, as separated in separation unit 140, may optionally be processed in silica recovery unit 170 to recover silica values. The amorphous silica typically present may readily be separated from refractory impurities by known methods.

In other embodiments, the stoichiometric imbalance between silicon and aluminium is addressed by introducing aluminium source 189, such as gibbsite, to one or more of the process steps. For example, aluminium source 192 may be added to alkaline treatment unit 100, acid extraction unit 120 or zeolite precursor preparation unit 150. This may advantageously allow a greater proportion of the silicon in acid-refractory mineral composition 102 to be converted to recoverable zeolite 162.

### Acid-Refractory Mineral Composition Comprising Aluminosilicate

In the most general form, the present disclosure provides methods for zeolite production from any acid-refractory mineral composition comprising aluminosilicate. As used herein, an acid-refractory mineral composition comprising aluminosilicate refers to a mineral composition comprising aluminosilicate which is poorly susceptible to hydrometallurgical processing using acid treatment to recover values therefrom. In such compositions, the aluminosilicate may predominantly be present in one or more phases from which aluminium cannot be extracted to a substantial extent using strong mineral acid lixiviants such as sulfuric acid, hydrochloric acid or nitric acid.

Non-limiting examples of acid-refractory mineral compositions comprising aluminosilicate include acid-treated mineral residues, including residues from extractive hydrometallurgical processes using acid lixiviants, clays (e.g. kaolinite), micas, feldspars and fly ash.

In some embodiments, the acid-refractory mineral composition comprises an acid-treated mineral residue, for example a leach residue from a lithium leach process. Lithium can be extracted by acid treatment of ores or concentrates containing a variety of lithium-bearing aluminosilicate minerals including spodumene, eucryptite, lepidolite, zinnwaldite and petalite, which may optionally be calcined prior to the extraction. In each case, the residue of the lithium extraction process will be an acid-refractory mineral composition comprising aluminosilicate.

In some embodiments, the acid-refractory mineral composition is a spodumene leach residue, in particular a β-spodumene leach residue. The β-spodumene leach residue may be the residue of lithium extraction from an α-spodumene-bearing ore or concentrate including steps of calcining to form β-spodumene, and sulfuric acid roasting and leaching of the roasted β-spodumene product to extract lithium. Spodumene leach residues generated by other acid-based processes, e.g. from nitric acid processing as proposed in WO 2017/106925, may also be used.

In some embodiments, the acid-refractory mineral composition comprises HAl(SiO₃)₂, for example in an amount of at least 20 wt. %, at least 30 wt. %, at least 40 wt. %, at least 50 wt. %, at least 60 wt. %, or at least 70 w.t % of the acid-refractory mineral composition.

The acid-refractory mineral composition may comprise various other components, as are expected in residues from mineral processing of ores or concentrates. Such components may include one or more minerals selected from a feldspar mineral (e.g. albite, orthoclase), quartz and gypsum (which can be formed by reaction of calcium in minerals subjected to sulfuric acid treatments).

The acid-refractory mineral composition is preferably in particulate form to facilitate processing according to the methods disclosed herein. In some embodiments, the acid-refractory mineral composition has a particle size distribution represented by a P80 value of less than 100 microns, or less than 60 microns, such as about 45 microns.

Alkaline Treatment with an Alkaline Solution

The methods disclosed herein involve a step of treating the acid-refractory mineral composition with an alkaline solution to dissolve silicon from the aluminosilicate into the alkaline solution, thereby producing an alkaline silicate solution and an aluminium-bearing mineral residue.

The alkaline solution is generally an aqueous alkaline solution, and may have a pH of greater than 10, or greater than 12, or greater than 13. The alkaline solution may contain a variety of suitable bases including but not limited to alkali metal hydroxides. For example, it is also envisaged that certain alkaline earth metal hydroxides may be used. In some embodiments, the alkaline solution comprises an alkali metal hydroxide base selected from lithium hydroxide, sodium hydroxide, potassium hydroxide and combinations thereof. The alkali metal hydroxide may be selected at least in part to provide a desired alkali metal cation or mixtures of cations in the final zeolite structure.

In some embodiments, the alkaline solution comprises sodium hydroxide, for example in a concentration of above 0.1 M, such as between 1 M and 15 M, or between about 4 M and about 10 M. Such alkaline solutions have been found by experiment to convert acid-refractory aluminosilicates, such as those found in 3-spodumene leach residue, to acid-extractable aluminosilicate phases at moderate temperatures with high conversion and controllable selectivity.

The acid-refractory mineral composition may thus be contacted with a preformed alkaline solution. However, it will be appreciated that the acid-refractory mineral composition may also be treated with an alkaline solution of desired concentration by other methods, including preparing a slurry of the acid-refractory mineral composition in water, and adding a concentrated or solid base to the slurry.

In some embodiments, the acid-refractory mineral composition is treated with the alkaline solution at a temperature of below 300° C., or below 250° C., or below 200° C., or below 150° C., or below about 100° C., such as between 50° C. and 100° C. In some embodiments, the temperature is at or below the normal boiling point of the alkaline solution. Advantageously, there is no need to employ energy-intensive high temperature processing of the acid-refractory mineral composition in the presently disclosed methods. Moreover, high pressures and the associated costs of pressure-rated equipment can be avoided when using low temperature alkaline processing conditions. In some embodiments, the acid-refractory mineral composition is thus treated with the alkaline solution at low pressure, for example below 5 bar, or below 2 bar, or about atmospheric pressure.

The alkaline treatment step may be conducted by producing a slurry of the acid-refractory mineral composition in the alkaline solution, the slurry having a suitable solids concentration to allow silicon dissolution and desirable aluminosilicate phase transformations. In some embodiments, the slurry has a solids concentration in the range of about 10% w/w solids to about 30% w/w solids.

The acid-refractory mineral composition may be treated with the alkaline solution for a time sufficient to transform the acid-refractory aluminosilicates into acid-extractable phases and dissolve the excess silicon component associated with the aluminosilicates. It will be appreciated that the required time may depend on various parameters such as the composition and physical form (e.g. particle size) of the acid-refractory mineral composition, the composition of the alkaline solution and the treatment temperature. In some embodiments, the time is less than 10 hours, or from about two hours to about six hours.

The alkaline treatment step transforms the acid-refractory aluminosilicates initially present in the acid-refractory mineral composition into one or more acid-extractable phases. Depending on the process conditions, these acid-extractable aluminosilicate phases may include aluminosilicate phases such as sodalites, e.g. hydroxysodalite (Na₈Al₆Si₆O₂₄(OH)₂·xH₂O), cancrinites, e.g. hydroxycancrinite (Na₄Al₃Si₂O₁₂OH·xH₂O) and/or zeolite phases such as Zeolite A (Na₁₂Al₁₂Si₁₂O₄₈·27H₂O), and Zeolite P1 (Na₆Al₆Si₁₀O₃₂·12H₂O). It has been found by experiment that hydroxysodalite and hydroxycancrinite phases predominate under conditions where maximum silicon extraction is favoured, e.g. by the use of highly alkaline solutions and longer contact times. By contrast, Zeolite P, which has a higher Si:Al ratio, is favoured under conditions where silicon dissolution is limited by the use of less alkaline solutions with high solids concentration in the slurry. Without wishing to be limited by any theory, it is proposed that the alkaline treatment initially produces zeolitic phases which are subsequently transformed into hydroxysodalite and hydroxycancrinite.

In some embodiments, the alkaline treatment step is conducted under conditions suitable to form zeolites, optionally as the most abundant aluminosilicate phase(s) of the aluminium-bearing mineral residue.

In some embodiments, the alkaline treatment step is conducted under conditions suitable to form sodalite, e.g. hydroxysodalite, and/or hydrocancrinite in the aluminium-bearing mineral residue as the most abundant aluminosilicate phase(s) of the aluminium-bearing mineral residue. The primary reaction believed to occur when β-spodumene leach residue is converted to hydroxysodalite is shown in Equation (1).

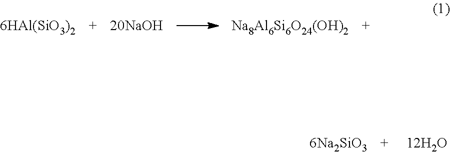

The alkaline treatment step thus causes a portion of the silicon initially present in refractory aluminosilicate phases to become dissolved in the alkaline solution. The silicon dissolves in the form of one or more silicate anions, such as SiO₃²⁻, so that an alkaline silicate solution is produced, typically having a pH of greater than 12. It will be appreciated that the maximum amount of silicon which can dissolve is limited by the chemical composition of the initial aluminosilicate phase(s) present in the acid-refractory mineral composition and the transformed phase(s) present in the aluminium-bearing mineral residue. It has been found by experiment that up to 37% of the silicon initially present in β-spodumene leach residue can be dissolved in high concentration caustic soda solutions, consistent with the transformation of a major portion of the HAl(SiO₃)₂ (Si:Al=2:1) initially present into aluminosilicate phases having a Si:Al of approximately 1:1.

The amount of silicon dissolved in the alkaline silicate solution may be intentionally limited, for example by adding an aluminium source, such as gibbsite, i.e. Al(OH)₃, to the alkaline treatment step. Excess silicon released by the aluminosilicate phase transformations thus reacts with the added aluminium to form further amounts of acid-extractable aluminosilicate solid phases in the aluminium-bearing mineral residue. The extent of silicon dissolution may be controlled in this (or other) ways to provide a desired stochiometric ratio of dissolved silicon in the alkaline silicate solution to acid-extractable aluminium in the aluminium-bearing mineral residue. Thus, the amount of silicon as needed in step (e) can be provided in the alkaline silicate solution, with excess silicon reporting to the aluminium-lean solid residue after acid treatment in step (c).

The alkaline treatment step may be conducted in conventional minerals processing equipment which is corrosion-resistant to the liquors being used and produced under the process conditions being used.

Separating the Alkaline Silicate Solution from the Aluminium-Bearing Mineral Residue

After the alkaline treatment step, the alkaline silicate solution is separated from the aluminium-bearing mineral residue. This may be done via conventional separation methodologies in minerals processing, such as filtration, centrifugation, thickening or clarification.

The separated aluminium-bearing mineral residue may optionally be washed, for example with water, in one or more wash steps to remove alkaline silicate solution retained in the wet solids. Optionally, the washings may be recombined with the main portion of the alkaline silicate solution.

The separation step may be conducted in a dedicated separation unit, e.g. a filtration unit or thickener, located downstream of the alkaline treatment unit as depicted in FIG. 1. However, it will be appreciated that the alkaline treatment and separation steps may be also be integrated in a single process unit.

The separated aluminium-bearing mineral residue may optionally be classified, for example to exclude coarser particles (e.g. >180 μm, or >90 μm, or >45 μm) which have been found to contain a higher proportion of impurities. The remainder of the aluminium-bearing mineral residue, which contains a high proportion of acid extractable aluminium-bearing phases, may then be sent to the acid extraction step.

Acid Extraction with an Acid Solution

After the separation step, at least a portion of, optionally all of, the aluminium-bearing mineral residue is contacted with an acid solution to dissolve aluminium from the aluminium-bearing mineral residue into the acid solution, thereby producing an aluminium salt solution and an aluminium-lean solid residue.

The acid solution is generally an aqueous acid solution, and may have a pH of below 2, such as below 1. The acid solution may comprise a mineral acid selected from sulfuric acid, hydrochloric acid and nitric acid. In some embodiments, the acid solution comprises hydrochloric acid (HCl), for example in a concentration of between 5% w/w HCl and 50% w/w HCl, such as between about 5% w/w HCl and about 20% w/w HCl. In other embodiments, the acid solution comprises sulfuric acid (H₂SO₄), for example in a concentration of between 5% w/w H₂SO₄ and 50% w/w H₂SO₄, such as between about 5% w/w H₂SO₄ and about 10% w/w H₂SO₄. Such exemplary acid solutions have been found by experiment to extract a high proportion of the aluminium in the aluminium-bearing mineral residue produced by alkaline treatment of β-spodumene residue.

The aluminium-bearing mineral residue may be contacted with a preformed acid solution. However, it will be appreciated that the aluminium-bearing mineral residue may also be contacted with an acid solution of desired concentration by other methods, for example preparing a slurry of the aluminium-bearing mineral residue in water and adding a concentrated acid to the slurry.

The aluminium-bearing mineral residue may be contacted with the acid solution under conditions suitable to dissolve a high proportion of the aluminium in the aluminium-bearing mineral residue. Since aluminium is generally the limiting component for zeolite synthesis, a high degree of aluminium extraction is particularly desirable. In some embodiments, at least 80%, or at least at least 90%, such as at least 95%, of the aluminium in the aluminium-bearing mineral residue is dissolved.

In some embodiments, the aluminium-bearing mineral residue is contacted with the acid solution at a temperature of below 100° C., such as between about 20° C. and about 80° C.

The acid extraction step may be conducted by producing a slurry of the aluminium-bearing mineral residue in the acid solution, the slurry having a suitable solids concentration to allow aluminium dissolution. The maximum solids concentration may be limited by the need to maintain flowability in the slurry. In some embodiments, the slurry has a solids concentration in the range of 1% w/w solids to 20% w/w solids, such as 2.5% w/w solids to 10% w/w solids.

The aluminium-bearing mineral residue may be treated with the acid solution for a time sufficient to dissolve the aluminium into the acid solution. It will be appreciated that the required time may depend on various parameters such as the composition of the aluminium-bearing mineral residue, the composition of the acid solution and the temperature. In some embodiments, the time is less than five hours, or less than two hours. Based on experimental observations, 30 minutes may be sufficient in at least some cases.

Dissolution of aluminium from the aluminium-bearing mineral residue produces an aluminium salt solution, containing aluminium sulfate, Al₂(SO₄)₃, or aluminium chloride, AlCl₃, or aluminium nitrate, Al(NO₃)₃, when the acid solution contains sulfuric acid, hydrochloric acid and nitric acid, respectively. The aluminium salt solution produced after fully dissolving the aluminium may have a pH value of below 3.5, or below 2.5, such as between 1 and 2. At such final pH values, a high proportion of the extractable aluminium will have been dissolved.

In some embodiments, the aluminium-bearing mineral residue is contacted with a sulfuric acid solution to dissolve the aluminium. The primary reaction believed to occur when hydroxysodalite (an exemplary acid-extractable aluminosilicate present in the aluminium-bearing mineral residue) is contacted with sulfuric acid is shown in Equation (2).

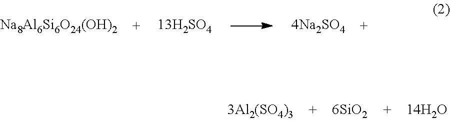

Dissolution of aluminium from the aluminium-bearing mineral residue into the acid solution leaves an aluminium-lean solid residue, which generally contains the silicon that was present in acid-extractable aluminosilicate phases of the aluminium-bearing mineral residue as well as insoluble impurities originating from the acid-refractory mineral composition, such as quartz and feldspars.

As seen in Equation (2), the aluminium-lean solid residue comprises silicon in the form of silica (SiO₂). It has been found by experiment that this silica forms as amorphous silica gel when conducting the acid extraction step at pH values below 3, such as between 1 and 2. The voluminous silica gel thus formed in the slurry potentially complicates the subsequent separation of the aluminium salt solution from the aluminium-lean solid residue.

The separation issues caused by silica gel formation may be addressed, or at least mitigated, by coagulating the silica gel. This may be done by adjusting the pH value of the aluminium salt solution in the slurry to between 3 and 5, such as between 3 and 4. At pH values in this range, the silica coagulates in the slurry, thus facilitating its subsequent separation from the aluminium salt solution by conventional solid-liquid separation techniques. When the pH of the aluminium salt solution is initially below 3 (e.g. between 1 and 2), silica coagulation may be achieved by alkalizing the solution with a base (such as NaOH) to increase the pH to the desired value. Optionally, a portion of the alkaline silicate solution (as produced in the alkaline treatment step) may be used as the alkalizing agent. The alkalized slurry may then be maintained at a temperature and for a time sufficient for the silica gel to coagulate, such as about 55° C. in the range of 30 minutes to four hours, such as for one to two hours. It has been found by experiment that silica can be coagulated in this manner without an unacceptable adverse effect on the aluminium recovery.

It is also proposed that a desirable coagulated silica morphology may be obtained directly by maintaining the pH of the aluminium salt solution in the slurry at a value between 3 and 5, such as between 3 and 4, throughout the aluminium extraction step. For example, this might be achieved by controlling the rate of addition of the acid solution to a slurry of the aluminium-bearing mineral residue.

Controlling the silica morphology via control or adjustment of the aluminium salt solution pH in this manner means that it is not necessary to pre-treat the aluminium-bearing mineral residue before acid extraction with process steps such as ammonium ion-exchange or heating. Thus, in some embodiments, the aluminium-bearing mineral residue is not subjected to an ion-exchange step before contacting the aluminium-bearing mineral residue with the acid solution. In some embodiments, the aluminium-bearing mineral residue is not subjected to heating at a temperature above 150° C. before contacting the aluminium-bearing mineral residue with the acid solution.

Optionally, an aluminium source, such as gibbsite, i.e. Al(OH)₃, may be added to the acid extraction step to increase the concentration of the aluminium salt solution.

The acid extraction step may be conducted in conventional minerals processing equipment which is corrosion-resistant to the liquors being used and produced and under the conditions being used.

Separating the Aluminium Salt Solution from the Aluminium-Lean Solid Residue

After the acid extraction step, the aluminium salt solution is separated from the aluminium-lean solid residue. This may be done via conventional separation methodologies in minerals processing, such as filtration, centrifugation, thickening or clarification.

As noted above, the aluminium-lean solid residue may comprise amorphous silica. The separation of the amorphous silica may be facilitated by pH control of the aluminium salt solution prior to or during the separation step.

The aluminium-lean solid residue may optionally be washed, for example with water, in one or more wash steps to remove aluminium salt solution retained in the wet solids. Optionally, the washings may be recombined with the main portion of the aluminium salt solution.

The separation step may be conducted in a separation unit, e.g. a filtration unit or thickener, located downstream of the acid extraction unit, as depicted in FIG. 1. However, it will be appreciated that the acid extraction and separation steps may be also be integrated in a single process unit.

Producing Zeolite from a Zeolite Precursor Solution

The methods disclosed herein include steps of combining at least a portion of the alkaline silicate solution and at least a portion of the aluminium salt solution to form a zeolite precursor solution and precipitating a zeolite from the zeolite precursor solution. The precipitated zeolite may then be separated from the depleted solution which contains residual dissolved components not precipitated from the zeolite precursor solution.

The zeolite precursor solution may be formed simply by mixing the alkaline silicate and aluminium salt solutions as separated after the alkaline treatment and acid extraction steps respectively. However, it is not excluded that the alkaline silicate solution and/or aluminium salt solution may be subjected to one or more modifications prior to their combination, including pH adjustment, dilution, concentration etc. Moreover, it is not excluded that additional components are added to the zeolite precursor solution, for example a soluble aluminium or silicon source to adjust the Si:Al ratio.

The alkaline silicate solution and the aluminium salt solution may be combined to produce a zeolite precursor solution having a desired composition, in particular a target Si:Al ratio. Thus, the methods disclosed herein may include steps of determining a silicon concentration (and optionally also an aluminium concentration) in the alkaline silicate solution and determining an aluminium concentration (and optionally also a silicon concentration) in the aluminium salt solution. The alkaline silicate solution and the aluminium salt solution may then be combined in relative amounts suitable to produce a target Si:Al ratio in the zeolite precursor solution, based on these known concentrations.

The zeolite precursor solution may be an alkaline solution, for example having a pH of above 12, or above 12.5.

For the purposes of zeolite synthesis, silicon may be in stoichiometric excess relative to aluminium present in the acid-refractory mineral composition. Therefore, to obtain a desirable Si:Al ratio in the zeolite precursor solution for zeolite synthesis, an aluminium source such as gibbsite may be added to the process. As already noted, one option is to add the aluminium source to the alkaline treatment step, thus reducing the amount of silicon dissolved in the alkaline silicate solution and increasing the amount of aluminium available for dissolution in the aluminium salt solution. Alternatively (or in addition) an aluminium source may be added to the zeolite precursor solution to supplement the aluminium derived from the acid-refractory mineral composition, thereby decreasing the Si:Al ratio closer to the stoichiometry of the zeolite products. The aluminium source may suitably be added to the zeolite precursor solution itself or at an earlier stage, e.g. during the acid extraction step or to the acidic aluminium salt solution.

Various different zeolite products may preferentially be precipitated from zeolite precursor solutions by controlling the Si:Al ratio. In some embodiments, the zeolite precursor solution has a Si:Al ratio of between 3:1 and 1:1, such as between 2.5:1 and 1.0:1. Higher Si:Al ratios are also contemplated, either to produce different zeolite products or simply to allow excess silicon in the process to be processed downstream of the zeolite precipitation step.

The properties of the zeolite products may be further controlled via the charge-balancing cations which crystallise in the zeolite structure. Zeolites with a desired metal cation or mixtures of cations in the final zeolite structure may be produced by selecting an appropriate alkali metal hydroxide base (or mixture of bases) for the alkaline treatment step, or by adding desired cations to the zeolite precursor solution.

Precipitation of the zeolite product(s) from the zeolite precursor solution may be induced by heating the zeolite precursor solution to a desired temperature for a time sufficient to allow the zeolites to precipitate and form well crystallised products. In some embodiments, the zeolite precursor solution is maintained at a temperature in the range of 60° C. to 110° C. during the precipitation. In some embodiments, the zeolite precursor solution is maintained at such temperatures for a time in the range of 6 hours to one week, such as about 24 hours to about 72 hours.

In one exemplary set of embodiments, Zeolite A is precipitated from the zeolite precursor solution. It has been shown by experiment that Zeolite 4A, the sodium form of Zeolite A, may be selectively precipitated according to the present disclosure from a zeolite precursor solution having an Si:Al ratio of about 2.2-2.3, maintained at about 70° C. The proposed reaction by which Zeolite 4A forms is shown in Equation (3).

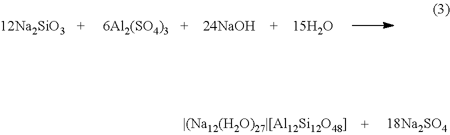

In another exemplary set of embodiments, Zeolite X is precipitated from the zeolite precursor solution. It has been shown by experiment that Zeolite X may be selectively precipitated according to the present disclosure from a zeolite precursor solution having an Si:Al ratio of about 1.0-1.6, maintained at about 70° C.

It has been observed that zeolites, including Zeolite A and X, precipitate more rapidly from zeolite precursor solutions according to the present disclosure in comparison to synthetic zeolitic precursor solutions derived from pure reagents. Without wishing to be bound by any theory, it is proposed that the zeolite crystallisation process is promoted by impurities present in one or both of the alkaline silicate and aluminium salt solutions, derived from the acid-refractory mineral composition.

Various zeolites, including Zeolite A and Zeolite X, may be precipitated from the zeolite precursor solution without the addition of extraneous templating reagents. In some embodiments, therefore, a templating reagent is not added to the zeolite precursor solution. In other embodiments, however, a templating reagent is added to induce selective precipitation of a desired zeolitic structure. The methods of the present disclosure provide an opportunity to use various known templating agents, including organic quaternary ammonium cations, to influence the structure of zeolites precipitated from Al- and Si-containing precursor solutions.

Optionally, zeolitic seed material may be added to the zeolite precursor solution to induce precipitation, to enhance the rate of zeolite precipitation or to control the selectivity or particle size of the zeolite products.

It is also envisaged that zeolite initially precipitated from the zeolite precursor solution may be transformed to a different zeolitic form via various mechanisms that include dissolution-reprecipitation and solid-state transformation or a combination of these mechanisms. Thus, for example, Zeolite X initially precipitated according to the present disclosure may be transformed into Zeolite P by hydrothermal treatment in an alkaline solution, for example treatment at 95° C. in 2 M NaOH solution.

### Processing Excess Silicon

As already noted, the Si:Al ratio in the acid-refractory mineral composition may be higher than the Si:Al ratio in the zeolite product. For example, the Si:Al ratio in β-spodumene leach residue may be about 2:1, based on its most abundant and reactive component, HAl(SiO₃)₂, whereas the Si:Al ratio of Zeolite 4A is 1:1. Thus, silicon is in stoichiometric excess.

At least a portion of the excess silicon may report to the aluminium-lean solid residue in the form of amorphous silica. This silicon may optionally be extracted from the aluminium-lean solid residue by known methods, for example to produce high purity silica as a further value-adding product of the process.

Alternatively (or in addition) a portion of the excess silicon in the acid-refractory mineral composition may be converted to desirable zeolite products by adding an aluminium source, such as gibbsite, to supplement the aluminium derived from the acid-refractory mineral composition. For example, the amorphous silica produced in the acid extraction step may be recycled to the alkaline treatment step to dissolve into the initial alkaline solution and/or the product alkaline silicate solution, thereby increasing the silicate concentration of the alkaline silicate solution. As described herein, the aluminium source may be added to one or more different process steps, e.g. the acid extraction step or the zeolite precipitation step, for reaction with the excess silicon in the alkaline silicate solution.

### Regenerating the Depleted Solution Following Zeolite Precipitation

Precipitation of zeolite from the zeolite precursor solution forms a depleted solution comprising residual dissolved components. These residual dissolved components include substantial amounts of by-product salts ultimately derived from the base and acid used in the alkaline treatment step and the acid extraction step respectively. Thus, in the case where the alkaline treatment step utilizes a caustic soda (NaOH) solution and the acid extraction step utilizes a sulfuric acid (H₂SO₄) solution, the depleted solution will contain sodium sulfate (Na₂SO₄); see equation (3). If a hydrochloric acid solution is used instead of sulfuric acid, the depleted solution will contain sodium chloride (NaCl).

It may be desirable to reconvert these salts to form a base (e.g. NaOH) which could then be recycled to the alkaline solution used in the alkaline treatment step, together with residual base already present in the (typically alkaline) depleted solution. This may be done by subjecting the depleted solution to bipolar membrane electrodialysis or electrolysis. For example, a depleted solution containing Na₂SO₄ may be regenerated to form a sodium hydroxide solution and a sulfuric acid solution by bipolar membrane electrodialysis. In another example, a depleted solution containing NaCl may be regenerated to form a sodium hydroxide solution by electrolysis, with formation of chlorine gas as by-product. In both cases, the sodium hydroxide solution may be recycled to the alkaline treatment step of the process. The regenerated sulfuric acid solution (produced by bipolar membrane electrodialysis) may be recycled to the acid extraction step.

In some embodiments, the depleted solution contains excess silicon in the form of silicates. This silicon can be removed, prior to any regeneration of the salts in the depleted solution, by adding lime to precipitate calcium silicate.

### EXAMPLES

The present invention is described with reference to the following examples. It is to be understood that the examples are illustrative of and not limiting to the invention described herein.

### Example 1. Analysis of β-Spodumene Leach Residue

A sample of β-spodumene leach residue was obtained from a commercial lithium processing plant. The residue had not been neutralised with limestone and therefore its calcium content was low. The material had a nominal P80 of 45 μm and 15% moisture but, was dried overnight at 70° C. before use. The elemental composition, determined both by assay and quantitative XRD (QXRD) analysis, is shown in Table 1 below.

TABLE 1

| Composition | Li | Na | K | Mg | Ca | Al | Fe | Si |
|---|---|---|---|---|---|---|---|---|
| type | wt. % | wt. % | wt. % | wt. % | wt. % | wt. % | wt. % | wt. % |
| Assay | 0.226 | 0.285 | 0.573 | 0.139 | 0.443 | 11.9 | 0.975 | 33.2 |
| QXRD | — | 0.31 | 0.12 | — | 0.22 | 12.0 | — | 33.6 |
| analysis | | | | | | | | |

For the QXRD analysis, two hydrogen aluminium silicate products of composition HAl(SiO₃)₂ with different space groups, constituting 77% of the residue, were modelled. Other components included residual feldspar minerals, albite (3.5%), orthoclase (0.9%), quartz (17.5%) and a minor by-product formed during lithium extraction, gypsum (0.9%). The QXRD analysis is consistent with the primary product from the leaching of β-spodumene being HAl(SiO₃)₂.

### Example 2. Treatment of β-Spodumene Leach Residue with Alkaline Solution

Treatment of the β-spodumene leach residue with caustic soda (NaOH) solution was conducted at a range of solids concentrations (10, 20, 30% w/w) and NaOH concentrations (4, 7, 10 M) in a Parr Instrument Company 2 L Inconel 600 autoclave over a period of 6 h with sampling at times of 0, 0.5, 1, 1.5, 2, 3, 4 and 6 h. The materials were charged to the vessel which was then sealed and heated to the target temperature of 107° C., 114° C. and 122° C. for experiments with 4 M, 7 M and 10 M NaOH respectively. The 0 h sample was taken when the target temperature had been reached, typically after just under 20 minutes of heating.

The residual solids and leach liquors of the sub-samples and final slurry were separated by vacuum filtration with the primary leach liquors submitted for analysis at least a few days after collection to allow for equilibration to occur. The solids were thoroughly washed with deionised water, dried overnight in an oven at 65-70° C. and submitted for analysis. Analysis of the liquor samples and of the solids, after fusion in 12:22 lithium tetraborate-lithium metaborate flux and dissolution in deionised water, were conducted via Inductively Coupled Plasma Optical Emission Spectroscopy (ICP-OES) using a Varian Vista Pro instrument. The solid and liquor samples were analysed for Al, Fe, Si, Mg, Ca, Na and K while the liquor samples were also analysed for Li.

Selected solid samples were back-pressed into a sample holder and analysed by X-Ray Diffraction (XRD). XRD measurements were carried out in a PANalytical high resolution multipurpose powder diffractometer (Empyrean). Cobalt Kα radiation was used, and the X-ray tube was operated at 45 kV and 40 mA. A Bragg-Brentano High Definition monochromator was inserted into the incident beam, while a PIXcel3D X-ray detector was used to collect the data over an angular range of 5-130° 2θ with a continuous scan mode. The instrument was also fitted with fixed incident beam anti-scatter (1°) and divergence slits (0.5°), fixed diffracted beam anti-scatter (0.125°) slit, and 0.02 radian incident and diffracted beam Soller slits.

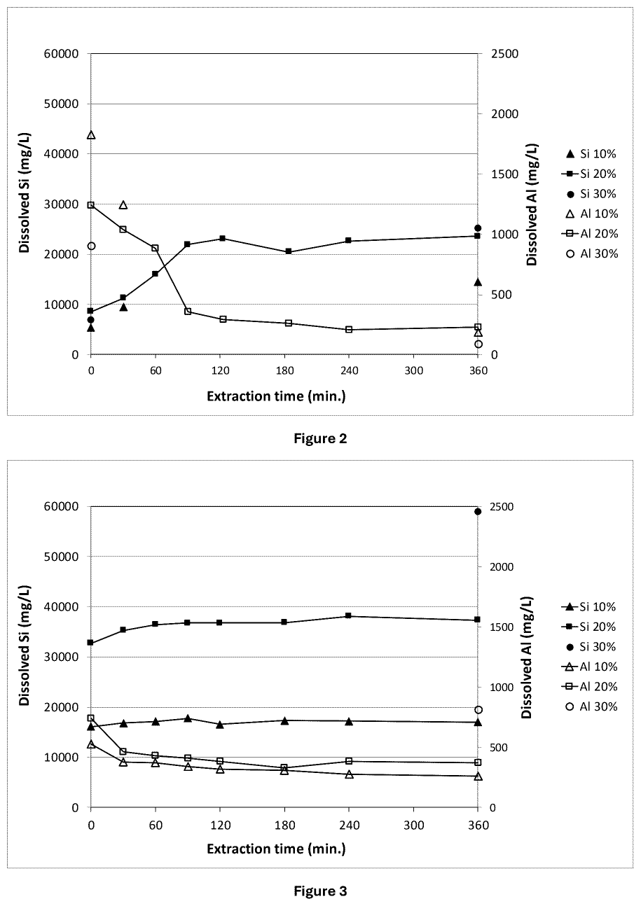

Solution analysis results of the alkaline treatment with 4 M NaOH and 10 M NaOH are shown in FIG. 2 and FIG. 3 respectively, which plot the silicon and aluminium concentrations present in the alkaline solution over time. In all experiments, a substantial portion of the silicon dissolved into the alkaline solution, while relatively little aluminium dissolved. It is evident that the full extent of dissolution was reached quickly at 10 M, whereas slower and/or incomplete dissolution occurred at 4 M. In the three experiments with 4 M NaOH, 15-34% of the silicon and 0.2-1.3% of the aluminium were dissolved in the final solution. In the three experiments with 7 M NaOH (not plotted), 27-36% of the silicon and 0.9-1.3% of the aluminium were dissolved in the final solution. In the three experiments with 10 M NaOH, 36-37% of the silicon and 0.6-2.4% of the aluminium were dissolved in the final solution.

The analysis also indicated that substantial amounts of the residual lithium and potassium present in the β-spodumene leach residue dissolved into the alkaline solution. Iron was also extracted, particularly at 10 M NaOH. If left standing, iron-containing solids precipitated from the filtered alkaline solutions.

The solution analysis results indicate that a portion of the silicon (up to about 37%) present in the β-spodumene leach residue can be dissolved in the caustic soda solution, with the dissolution assisted by higher caustic soda concentrations and temperatures. Relatively little aluminium is dissolved.

The elemental composition of the alkaline-treated solid residue, determined by assay, is shown in Table 2 below. The results confirm significant extraction of silicon and substantial increase in sodium content, suggesting the formation of new phase(s).

TABLE 2

| | | Composition of alkaline-treated solid residue | | | | | | | | | |
|---|---|---|---|---|---|---|---|---|---|---|---|
| Test condition | | Li | | | | | | | | | |
| Solids | NaOH | Calc. | Na | K | Mg | Ca | Al | Fe | Si | | % Si |
| % w/w | M | wt. % | wt. % | wt. % | wt. % | wt. % | wt. % | wt. % | wt. % | Na:Al | extracted |
| — ^{a} | — ^{a} | 0.226 | 0.285 | 0.573 | 0.139 | 0.443 | 11.9 | 0.975 | 33.2 | 0.03 | — |
| 10 | 4 | 0.074 | 9.55 | 0.320 | 0.164 | 0.541 | 11.9 | 1.14 | 23.0 | 0.94 | 34.2 |
| 10 | 7 | 0.066 | 12.1 | 0.215 | 0.166 | 0.517 | 12.6 | 0.958 | 21.4 | 1.12 | 35.6 |
| 10 | 10 | 0.073 | 11.9 | 0.208 | 0.158 | 0.501 | 12.6 | 1.07 | 22.9 | 1.11 | 37.8 |
| 20 | 4 | 0.073 | 8.98 | 0.314 | 0.117 | 0.381 | 11.6 | 0.621 | 21.0 | 0.95 | 26.9 |
| 20 | 7 | 0.082 | 10.8 | 0.288 | 0.161 | 0.496 | 11.9 | 0.883 | 20.9 | 1.06 | 31.5 |
| 20 | 10 | 0.071 | 12.4 | 0.191 | 0.157 | 0.529 | 12.7 | 1.02 | 22.0 | 1.15 | 37.3 |
| 30 | 4 | 0.071 | 7.20 | 0.483 | 0.150 | 0.444 | 10.0 | 0.944 | 25.0 | 0.85 | 14.7 |
| 30 | 7 | 0.120 | 10.6 | 0.393 | 0.161 | 0.498 | 12.1 | 1.00 | 22.9 | 1.03 | 26.8 |
| 30 | 10 | 0.107 | 12.3 | 0.267 | 0.127 | 0.411 | 13.5 | 0.729 | 20.6 | 1.07 | 35.9 |

^{a} composition of the β-spodumene leach residue prior to alkaline treatment.

XRD analysis was performed to identify the major phases in the solid residues. Various alum inosilicates and zeolites were present as the predominant phases, including hydroxysodalite (Na₈Al₆Si₆O₂₄(OH)₂·xH₂O), hydroxycancrinite (Na₄Al₃Si₂O₁₂OH·xH₂O), Zeolite A (Na₁₂Al₁₂Si₁₂O₄₈·27H₂O), which has a similar structure to dehydrated Zeolite 4A, and Zeolite P1 (Na₆Al₆Si₁₀O₃₂·12H₂O). However, also present were smaller amounts of quartz (SiO₂), albite (NaAlSi₃O₈) and other feldspar minerals (e.g. orthoclase, microcline or sanidine; each KAlSi₃O₈) which were already present in the β-spodumene leach residue.

The type and relative amounts of the zeolite phases present depended on the alkaline treatment conditions, as shown in Table 3. Under conditions of high NaOH concentration and low solids concentration where NaOH was present in excess, hydroxysodalite and hydroxycancrinite were the primary aluminosilicate phase formed. By contrast, at low NaOH concentration and high solids concentration where NaOH availability was limiting, less silicon was dissolved and zeolite P1 (which has a higher Si:Al ratio than the other zeolites) predominated.

TABLE 3

| Test condition | | Composition of alkaline-treated solid residue | | |
|---|---|---|---|---|
| Solids | NaOH | | % Si | |
| % w/w | M | Na:Al | extracted | Zeolites formed |
| 10 | 4 | 0.94 | 34.2 | Hydroxysodalite (major), Zeolite A (minor) |
| 10 | 7 | 1.12 | 35.6 | Hydroxysodalite (major) |
| 10 | 10 | 1.11 | 37.8 | Hydroxysodalite (major), Hydroxycancrinite |
| | | | | (major, well ordered) |
| 20 | 4 | 0.95 | 26.9 | Zeolite P1 (major) |
| 20 | 7 | 1.06 | 31.5 | Hydroxysodalite (major), Hydroxycancrinite |
| | | | | (moderate) |
| 20 | 10 | 1.15 | 37.3 | Hydroxycancrinite (major, well ordered) |
| 30 | 4 | 0.85 | 14.7 | Zeolite P1 (major) |
| 30 | 7 | 1.03 | 26.8 | Hydroxycancrinite (major) |
| 30 | 10 | 1.07 | 35.9 | Hydroxysodalite (major), Hydroxycancrinite |
| | | | | (major) |

### Example 3. Treatment of β-Spodumene Leach Residue with Alkaline Solution, with Added Gibbsite

The β-Spodumene Leach Residue was Again Treated with Caustic Soda (NaOH) solution at 10% w/w solid concentrations and varying NaOH concentrations (4, 7, 10 M) according to the method of Example 2, except that gibbsite was added to the autoclave in 10% excess to the amount of dissolved silicon expected in the end of reaction alkaline solution in the absence of added gibbsite (i.e. in the corresponding experiment in Example 2). As seen in Table 4, the added aluminium reduced the amount of silicon dissolved in the end of reaction alkaline solution substantially and, increased the amount of solid residue. XRD analysis of the solid residue indicated the formation of hydroxysodalite and hydroxycancrinite phases.

TABLE 4

| Leach residue | NaOH | Gibbsite | Si | Al dissolved |
|---|---|---|---|---|
| % w/w | M | added | dissolved | (mg/L) |
| 10 | 4 | No | 14524 | 189 |
| 10 | 7 | No | 16490 | 218 |
| 10 | 10 | No | 16998 | 262 |
| 10 | 4 | Yes | 828 | 596 |
| 10 | 7 | Yes | 1532 | 1123 |
| 10 | 10 | Yes | 1336 | 1856 |

The results demonstrate that an aluminium source such as gibbsite can be added to the alkaline treatment step to reduce the amount of silicon dissolved in the alkaline silicate solution and increase the amount of readily acid dissolvable aluminosilicate phase(s) in the solid residue. This can be done to the extent necessary to provide a desired stochiometric ratio of silicon content in the alkaline silicate solution to dissolved aluminium content in the aluminium salt solution (following extraction with the acid solution), thereby facilitating the formation of the ultimate zeolite products with high yields.

### Example 4. Aluminium Dissolution from Alkaline Treated Reside into Hydrochloric Acid Solution

The dissolution of aluminium into hydrochloric acid (HCl) was investigated using the alkaline-treated mineral residue produced by treating β-spodumene leach residue with 10 M NaOH solution at 30% w/w solids concentration in Example 2. As seen in Table 3, that residue contained hydroxysodalite and hydroxycancrinite as the major phases. The alkaline-treated mineral residue was size fractioned; fractions of −25 μm and +25-45 μm (together representing about 74% of the total mass) were retained while the fractions of larger particles, which contained most of the quartz and other impurities, were discarded. The elemental compositions of the various fractions, with comparison against the overall composition before fractionation, is shown in Table 5.

TABLE 5

| | | | Li | | | | | | | |
|---|---|---|---|---|---|---|---|---|---|---|
| | Weight | Weight | Calc. | Na | K | Mg | Ca | Fe | Al | Si |
| Fraction | (g) | (%) | wt. % | wt. % | wt. % | wt. % | wt. % | wt. % | wt. % | wt. % |
| Un- | 440.31 | 100 | 0.107 | 12.3 | 0.267 | 0.127 | 0.411 | 0.729 | 13.5 | 20.6 |
| fractionated | | | | | | | | | | |
| −25 μm | 236.37 | 53.7 | N/D | 12.1 | 0.241 | 0.184 | 0.813 | 0.709 | 14.3 | 19.2 |
| +25, −45 μm | 88.03 | 20.0 | N/D | 10.6 | 0.323 | 0.171 | 0.586 | 1.01 | 12.5 | 22.1 |
| +45, −90 μm | 115.92 | 26.3 | N/D | 8.46 | 0.414 | 0.219 | 0.672 | 1.41 | 10.6 | 25.7 |
| +90, −180 μm | 38.63 | 8.8 | N/D | 5.95 | 0.463 | 0.269 | 0.765 | 1.75 | 8.22 | 29.8 |
| +180, −355 μm | 1.15 | 0.3 | N/D | 3.00 | 0.279 | 0.222 | 2.05 | 3.88 | 4.89 | 33.8 |
| +355 μm | 0.21 | 0.1 | N/D | 2.89 | 0.129 | 0.133 | 11.3 | 16.8 | 3.50 | 12.1 |

N/D = not determined

The acid dissolution experiments were conducted at a range of solids concentrations (2.5, 5, 10, 15% w/w), HCl concentrations (10, 15, 20% w/w) and temperatures (25, 50, 75° C.). Hydrochloric acid solution of desired concentration was combined with the alkaline-treated mineral residue in 250 mL Nalgene bottles in a Grant shaking water bath that was set to the target temperature. A single up-front sighter test was used to determine that leaching for 2 h would be employed in the study.

The residual solids and leach liquors of the final slurry were separated by vacuum filtration and submitted for analysis as described in Example 2. Free acid determinations were performed using the CaEDTA method with first derivative detection of the titration end point using Metrohm Tiamo software. The solid residue from the HCl treatment was processed for analysis by re-pulping in 2 L deionised water, decanting and repeating until the pH of the decanted water was above 3. The solids were filtered and dried at 65° C. for 24 h.

The metal extractions and final free acidities obtained after the experiments are presented in Table 6. In all experiments, a very high degree of aluminium dissolution was obtained (>93%), except for the experiment at 25° C., 10% w/w acid and 15% w/w solids, which was limited in acid availability (as seen from the low free acid value). The silicon remained predominantly in the solid residue, and the silicon that did dissolve under the reaction conditions tended to precipitate out of the post-reaction filtered solution as an amorphous silica gel in many of the experiments. This was addressed to enable the collection and analysis of the filtrate by diluting the filtered solution with water and refiltering prior to the analysis.

TABLE 6

| | | | | | | | | | | | Free |
|---|---|---|---|---|---|---|---|---|---|---|---|
| Temp | HCl | Solids | Li | Na | K | Mg | Ca | Fe | Al | Si | acid |
| ° C. | % w/w | % w/w | % | % | % | % | % | % | % | % | (g/L) |
| 25 | 10 | 5 | 25.6 | 99.1 | 47.5 | 69.2 | 86.9 | 40.7 | 94.1 | 3.3 | 75 |
| 25 | 20 | 5 | 40.6 | 99.1 | 48.3 | 67.5 | 86.9 | 50.2 | 93.7 | 1.5 | 183 |
| 25 | 10 | 15 | 33.6 | 99.2 | 45.2 | 51.1 | 83.4 | 15.9 | 83.4 | 2.7 | 17 |
| 25 | 20 | 15 | 44.8 | 99.3 | 53.3 | 71.8 | 88.4 | 50.4 | 94.4 | 0.0 | 101 |
| 75 | 10 | 5 | 44.9 | 99.3 | 51.2 | 74.8 | 91.8 | 61.2 | 94.5 | 7.0 | 76 |
| 75 | 20 | 5 | 42.3 | 99.3 | 52.1 | 77.6 | 93.1 | 82.1 | 94.8 | 0.2 | 185 |
| 75 | 10 | 2.5 | 42.0 | 99.2 | 51.8 | 81.1 | 92.6 | 64.2 | 95.4 | 61.0 | 91 |
| 75 | 20 | 2.5 | 42.9 | 99.4 | 49.5 | 74.1 | 90.2 | 66.5 | 94.5 | 0.2 | 200 |
| 50 | 15 | 10 | 43.4 | 99.3 | 49.3 | 76.4 | 92.5 | 70.8 | 95.0 | 0.2 | 95 |
| 50 | 15 | 10 | 44.2 | 99.1 | 51.5 | 73.5 | 89.7 | 50.4 | 95.1 | 0.1 | 95 |

XRD analysis of the filtered solid residue following acid extraction indicated that the silicon in the residue was primarily amorphous silica, together with minor impurity phases such as quartz, feldspars, hematite and trace amounts of α-spodumene that had remained unconverted during the concentrate roasting process.

### Example 5. Zeolite Synthesis from Synthetic Alkaline Silicate and Aluminium Salt Solutions

Synthetic alkaline silicate and aluminium sulfate solutions were prepared as follows. A solution of sodium hydroxide containing dissolved silica was prepared by dissolving sodium hydroxide in water followed by addition of silica flour with heating until the silica had dissolved. This solution was filtered to remove any fine insoluble components and made up to volume to produce a synthetic alkaline silicate solution with the desired concentration. A solution of aluminium sulfate was prepared by dissolving Al₂(SO₄)₃.18H₂O in water. This solution was filtered to remove any fine insoluble components and made up to volume to produce a synthetic aluminium sulfate solution with the desired concentration.

Zeolites were synthesized by combining weighed amounts of the two synthetic solutions in Teflon bottles which were then sealed and shaken. The homogenised mixtures were placed in a shaking water bath set to the desired temperature and left for selected periods of time. The solid product was collected by filtration through a Buchner funnel, and repulped with filtration and washing several times before drying overnight in an oven at 70° C. The dried products were submitted for XRD analysis to characterise the mineralogy of the phase(s) present.

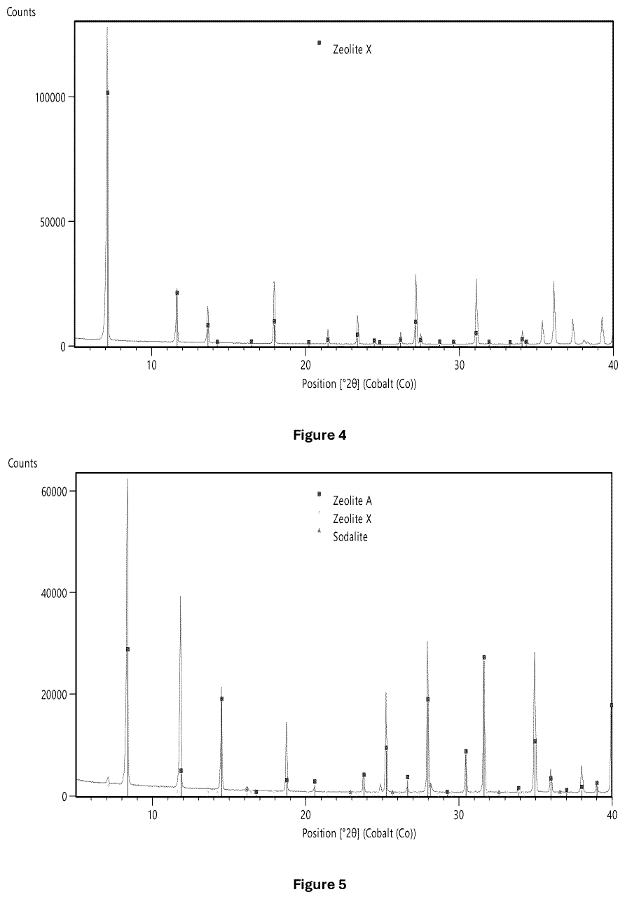

Zeolite X was prepared by mixing 150 mL of a synthetic alkaline silicate solution containing 106 g/L NaOH and 25.1 g/L silica (63 mmol dissolved silicon) with 50 mL of a synthetic aluminium sulfate solution containing 292.0 g/L Al₂(SO₄)₃·18H₂O (27 mmol dissolved aluminium) and heating at 70° C. for 72 h. The Si:Al ratio in the initial combined solution was thus 2.3. The yield of solid product was 5.1 g. XRD analysis indicated that the solid product was high purity Zeolite X, as seen in FIG. 4.

Zeolite A was prepared by mixing 150 mL of a synthetic alkaline silicate solution containing 106 g/L NaOH and 17.5 g/L silica (44 mmol dissolved silicon) with 50 mL of a synthetic aluminium sulfate solution containing 292.0 g/L Al₂(SO₄)₃·18H₂O (27 mmol dissolved aluminium) and heating at 70° C. for 72 h. The Si:Al ratio in the initial combined solution was thus 1.6. The yield of solid product was 6.8 g. XRD analysis indicated that the solid product was Zeolite A in good purity (trace impurities of Zeolite X and sodalite), as seen in FIG. 5.

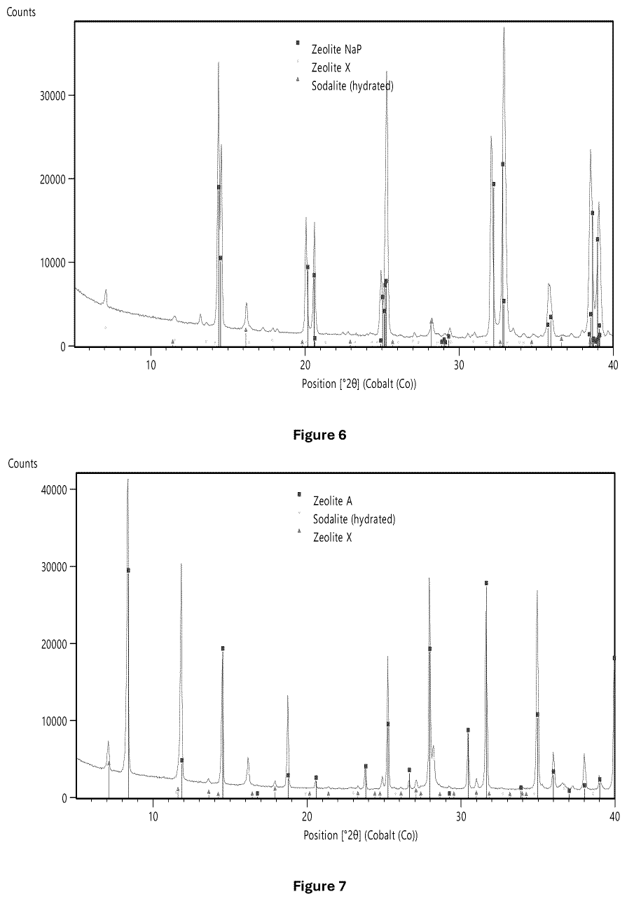

Zeolite P was prepared by mixing 10 g of the Zeolite X product into 100 mL 2 M NaOH solution and heating at 95° C. for 240 h. The yield of product was 8.3 g. XRD analysis indicated that the solid product was predominantly Zeolite P, with minor amounts of Zeolite X and sodalite also present, as seen in FIG. 6.

### Example 6. Zeolite Synthesis from β-Spodumene Leach Residue

An amount of 108 g of β-spodumene leach residue (as characterised in Example 1) was treated with 2295 g of 3.88 M NaOH solution (mass ratio of NaOH to residue=310 g:108 g; 4.5 wt. % leach residue in slurry). The mixture was stirred for 6 h at 105° C. After filtration, 93 g treated solid was recovered. The post-reaction alkaline silicate solution (2182 g recovered) had the following composition (g/L):Li (0.126), Na (76.6), K (0.198), Al (0.127) and Si (5.68).

A portion of the treated solids, 84 g, was slurried in 995 g water and 101 g of concentrated sulfuric acid was then added. The slurry, containing 7.1% w/w solids and 8.8% w/w H₂SO₄, was mixed and heated to 55° C. The slurry thus formed generated finely dispersed silica gel. The pH of the slurry was adjusted from 1.4 to 3.2 by the addition of concentrated NaOH solution, causing the silica gel to coagulate, and the final slurry was conditioned for about 2 h. After filtration, 61 g of solid residue was recovered. The acidic solution now containing dissolved aluminium sulfate (840 g solution recovered) had the following composition (g/L):Li (0.012), Na (16.2), K (0.032), Mg (0.064), Ca (0.254), Al (8.2), Si (0.172) and S (20.3).

Zeolite A was produced by mixing 81 mL of the alkaline silicate solution (16.4 mmol dissolved silicon, 0.4 mmol dissolved aluminium) with 54 mL acidic aluminium salt-containing solution (0.3 mmol dissolved silicon, 16.4 mmol dissolved aluminium) and heating to 70° C. for 24 h. The Si:Al ratio in the initial combined solution was thus 1.03. XRD analysis indicated that the recovered solid product mainly consisted of Zeolite A, with trace amounts of Zeolite X and sodalite as seen in FIG. 7.

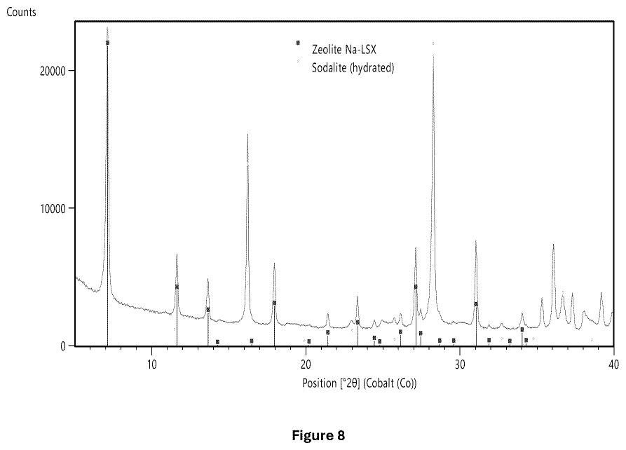

Zeolite X was produced by mixing 116 mL of the alkaline silicate solution (23.5 mmol dissolved silicon, 0.5 mmol dissolved aluminium) with 33 mL acidic aluminium salt-containing solution (0.2 mmol dissolved silicon, 10.0 mmol dissolved aluminium) and heating to 70° C. for 24 h. The Si:Al ratio in the initial combined solution was thus 2.30. XRD analysis indicated that the recovered solid product was high purity Zeolite X with trace sodalite, as seen in FIG. 8.

The time required to produce both zeolites using the solutions derived from β-spodumene leach residue was less than required using the synthetic solutions (in Example 5). Without wishing to be limited by any theory, it is proposed that impurities in the real solutions enhance the rate of zeolite formation.

Those skilled in the art will appreciate that the invention described herein is susceptible to variations and modifications other than those specifically described. It is understood that the invention includes all such variations and modifications which fall within the spirit and scope of the present invention.

1. A method of producing zeolite from an acid-refractory mineral composition, the method comprising:
treating an acid-refractory mineral composition comprising aluminosilicate with an alkaline solution to dissolve silicon from the aluminosilicate into the alkaline solution, thereby producing an alkaline silicate solution and an aluminum-bearing mineral residue;
separating the alkaline silicate solution from the aluminum-bearing mineral residue;
contacting at least a portion of the aluminum-bearing mineral residue with an acid solution to dissolve aluminum from the aluminum-bearing mineral residue into the acid solution, thereby producing an aluminum salt solution and an aluminum-lean solid residue;
separating the aluminum salt solution from the aluminum-lean solid residue;
combining at least a portion of the alkaline silicate solution and at least a portion of the aluminum salt solution to form a zeolite precursor solution; and
precipitating a zeolite from the zeolite precursor solution.

2. The mineral according to claim 1, wherein the acid-refractory mineral composition comprises an acid-treated mineral residue.

3. The method according to claim 1, wherein the acid-refractory mineral composition comprises a leach residue from a lithium leach process.

4. (canceled)

5. The method according to claim 1, wherein the acid-refractory mineral composition comprises HAl(SiO₃)₂.

6. (canceled)

7. The method according to claim 1, wherein the aluminum-bearing mineral residue comprises one or more acid-extractable phases selected from sodalites, cancrinites, and zeolites.

8. The method according to claim 1, wherein the acid-refractory mineral composition is treated with the alkaline solution at a temperature of below 300° C.

9. The method according to claim 1, wherein the aluminum salt solution produced by contacting the aluminum-bearing mineral residue with the acid solution has a pH value of below 3.5.

10. The method according to claim 1, wherein the aluminum-lean solid residue comprises silica.

11. The method according to claim 10, wherein the silica is coagulated by controlling or adjusting the pH of the aluminum salt solution to between 3 and 5 before separating the aluminum salt solution from the aluminum-lean solid residue.

12. The method according to claim 11, wherein the pH of the aluminum salt solution is adjusted by alkalizing the aluminum salt solution initially produced by contacting the aluminum-bearing mineral residue with the acid solution.

13. The method according to claim 12, wherein the aluminum salt solution initially produced is alkalized with a portion of the alkaline silicate solution.

14. The method according to claim 1, further comprising at least one of (i) extracting residual silicon from the aluminum-lean solid residue for the production of high purity silica, and (ii) dissolving residual silicon from the lean solid residue in the alkaline solution or the alkaline silicate solution.

15. The method according to claim 1, further comprising adding an aluminum source to supplement the aluminum present in the zeolite precursor solution as derived from the acid-refractory mineral composition.

16. The method according to claim 1, wherein the alkaline solution comprises an alkali metal hydroxide selected from lithium hydroxide, sodium hydroxide, potassium hydroxide, and mixtures thereof.

17. The method according to claim 1, wherein the acid solution comprises an acid selected from sulfuric acid, hydrochloric acid, nitric acid, and mixtures thereof.

18. The method according to claim 17, wherein the method further comprises:
separating the precipitated zeolite from a depleted solution comprising alkali metal sulfate or alkali metal chloride salt; and
regenerating alkali metal hydroxide base for the alkaline solution by bipolar membrane electrodialysis or electrolysis of the depleted solution.

19. The method according to claim 1, wherein precipitating a zeolite from the zeolite precursor solution comprises selectively precipitating a target zeolite by controlling precipitation process parameters comprising the Si:Al ratio in the zeolite precursor solution.

20. The method according to claim 19, wherein the Si:Al ratio is controlled by at least one selected from (i) controlling the relative amounts of the alkaline silicate solution and the aluminum salt solution combined in the zeolite precursor solution and (ii) adding an aluminum source to the zeolite precursor solution.

21. The method according to claim 1, wherein precipitating the zeolite from the zeolite precursor solution comprises maintaining the zeolite precursor solution at a temperature in the range of 60° C. to 110° C.

22. The method according to claim 1, wherein the zeolite is selected from the group consisting of Zeolite A, Zeolite X, Zeolite P, and combinations thereof.
